(19) United States
(12) Patent Application Publication
(10) Pub. No.: US 2002/0097631 A1
(43) Pub. Date: Jul. 25, 2002

(54) Dual converyor apparatus for cement-making materials

(76) Inventor: Daniel A. Anderson, Fleetwood, PA (US)

Correspondence Address: Richard P. Gilly, Intellectual Property Law Offices, One Penn Center- Suite 1500, 1617 John F. Kennedy Boulevard, Philadelphia, PA, 19103-1815, US

(21) Appl. No.: 09/769,055

(22) Filed: Jan. 24, 2001

(51) Int. Cl. B28C 7/04

(52) U.S. Cl. 366/8; 366/20

(57) ABSTRACT

A dual conveyor apparatus transports two cement-making materials in opposite directions. The two conveyors share a common channel so that the materials intermix during transport. The conveyors a driven by a motor, one conveyor rotating in a first direction and the other conveyor rotating in the opposite direction. Each conveyor extends upwardly at an incline from its feed end to its discharge end. The rotation of each conveyor can be altered to vary both the blend and the throughput of the device.

### FIELD OF THE INVENTION

The intention relates to apparatus for making cement, and, more particularly, to a dual conveyor apparatus for mixing two materials used in cement-making.

### BACKGROUND

Dust from kiln used in making cement is generally classified as a hazardous waste. It is nonetheless economically desirable to make us of kiln dust in making cement. Accordingly, in order to use kiln dust in the process of making cement, cement companies generally combine it with rock gypsum. However, it is difficult to combine rock gypsum with kiln dust. As an alternative, companies are using synthetic gypsum because it is easier to combine with kiln dust. The current machinery for combining synthetic gypsum and kiln dust requires at least three different components: a pug mill to blend the two materials, and two devices to feed the material separately into the pug mill unit. The devices that feed the materials into the pug mill are usually conveyor belts.

One of the drawbacks to the current art design is that the machinery is not adjustable as far as the feed rate of either material. In other words, it is difficult to adjust the proportion of kiln dust to synthetic gypsum.

Furthermore, the use of three separate components to combine the synthetic gypsum and kiln dust is often uneconomical, impractical, or cumbersome.

### BRIEF DESCRIPTION OF THE DRAWING

The invention will be better understood by reference to the attached drawing. It is understood that the drawing is for illustrative purposes only and is not necessarily drawn to scale. In fact, certain features of the drawing are shown in more detail for purposes of explanation and clarification.

FIG. 1 is a schematic view of a cement-making apparatus incorporating the dual conveyor apparatus of the present invention;

FIG. 2 shows a perspective view of the dual conveyor apparatus of FIG. 1;

FIG. 3 shows a top plan view of the dual conveyor apparatus of FIG. 2;

FIG. 4 shows a side elevational view of the dual conveyor apparatus of FIG. 2;

FIG. 5 shows an end elevational view of the dual conveyor system of FIG. 2; and

FIG. 6 shows a partial view showing the intermixing zone of the dual conveyor system of FIG. 2.

### SUMMARY OF THE INVENTION

in one aspect of the invention, an apparatus mixes and conveys cement-making materials from at least two sources. The apparatus includes first and second screw conveyors which extend longitudinally through a channel. The screw conveyors are secured generally next to each other and share the channel over a majority of the respective, operative lengths of the screw conveyors. In this way, material conveyed by one of the screw conveyors intermixes with material conveyed by the other of the screw conveyors, and the resulting mixture is ultimately discharged from the apparatus for further processing.

In accordance with another aspect of the present invention, each of the screw conveyors is inclined slightly upwardly from their respective feed ends, preferably at an angle of approximately 3° from horizontal. The two screw conveyors, in another aspect of the present invention, include a primary screw conveyor with a diameter about two times that of the other, secondary screw conveyor.

### DESCRIPTION OF THE INVENTION

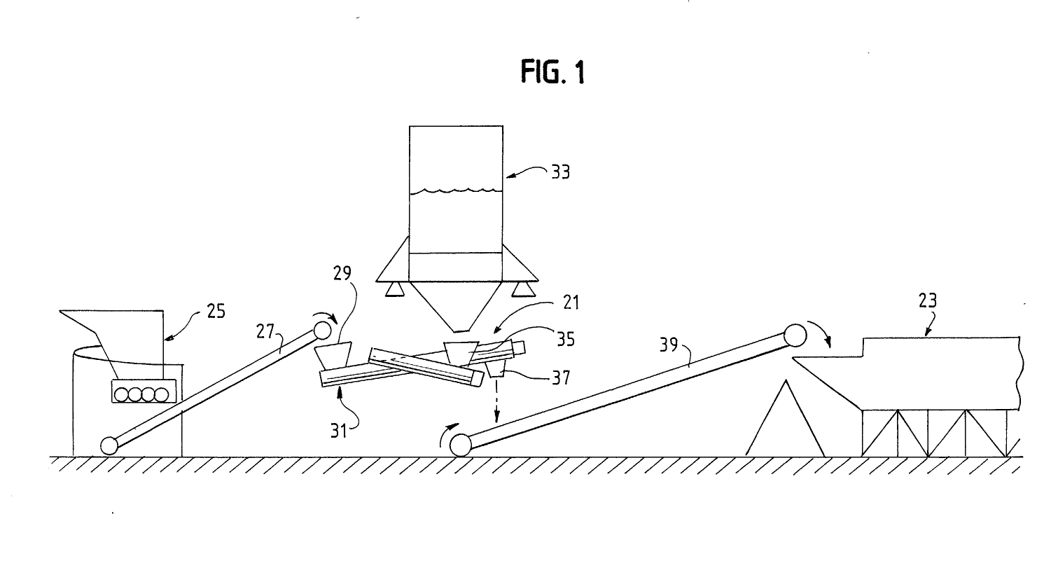

A dual conveyor apparatus 21, according to the present invention, is particularly well suited for use in the cement-making process shown schematically in FIG. 1. The dual conveyor apparatus 21 is shown intermixing and transporting synthetic gypsum and kiln dust or slag to improve the operations of cement mill 23. The cement-making materials handled by dual conveyor apparatus 21 are introduced to apparatus 21 from two sources. First, synthetic gypsum is stored in synthetic gypsum feeder 25. Such synthetic gypsum feeders are generally known in the art, an example of which is disclosed in U.S. Pat. No. 6,403,435, by the same inventor, the teachings of which are incorporated herein by reference. The synthetic gypsum is discharged onto belt conveyor 27 which feeds the synthetic gypsum into a hopper 29.

As discussed in more detail below, apparatus 21 comprises two or “dual” conveyors, shown only schematically in FIG. 1. Hopper 29 is located at feed end 31 of the primary one of the conveyors of apparatus 21. As describe above, synthetic gypsum feeder 25 is thus operatively connected to hopper 29 of the primary screw conveyor of apparatus 21.

Kiln dust is stored in any of a variety of suitable vessels, such as bin 33 shown schematically in FIG. 1.

The kiln dust or slag is delivered from bin 33 into a hopper 35, which hopper 35, in turn, is located at the feed end of the secondary screw conveyor of apparatus 21.

The synthetic gypsum and kiln dust/slag are intermixed in apparatus 21 without needing a pug mill, and in a manner described subsequently, and the resulting mixture is discharged through discharge end 37 onto a second belt conveyor 39, which transports the mixture toward cement mill 23 for further processing.

The cement-making process described above is exemplary only and, it will be appreciated by those skilled in the art, that the invention is also suitable in other cement making or similar processes using variations of and additions to the apparatus described above.

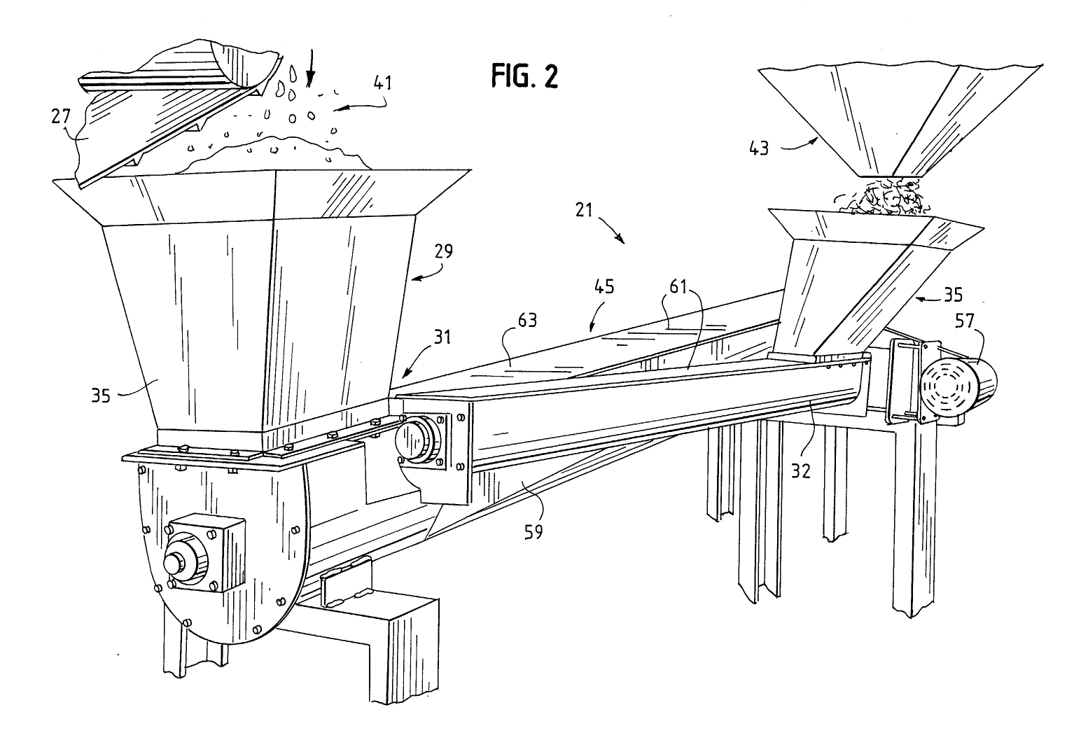

Referring to FIGS. 2-6, the dual conveyor apparatus 21 receives cement-making materials from two sources 41, 43. Such cement-making materials preferably comprise synthetic gypsum and kiln dust or slag, respectively. The two sources of cement-making materials are fed into their corresponding hoppers 29, 35, and the hoppers, in turn, feed their respective cement-making materials into a housing 45.

Housing 45 is substantially comprised of an elongated channel 47, into which are received first and second screw conveyors 49, 51. The arrangement of these screw conveyors within channel 47 accomplishes advantageous intermixing of the two source materials while, at the same time, transporting the mixture for further processing in cement-making. Each of the screw conveyors 49, 51 has a corresponding operative length 53, meaning that cement-making materials are transported and intermixed over such lengths of the screw conveyors. Screw conveyors 49, 51 extend longitudinally through channel 47. Hoppers 29, 35 are located at corresponding feed ends 31, 32.

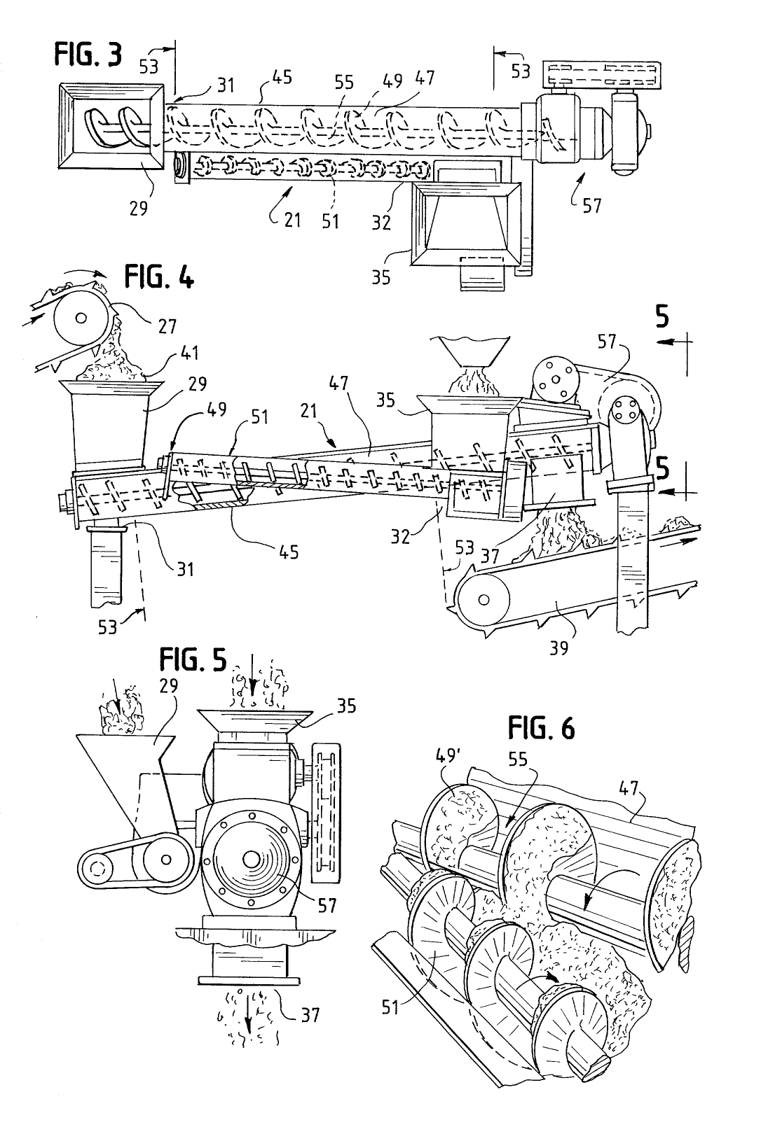

As best seen in FIG. 3, screw conveyors 49, 51 are secured generally next to each other to share elongated channel 47 over a majority of the operative lengths 53 as screw conveyors 49, 51. As best seen in FIGS. 2 and 4, screw conveyor 49 is oriented to convey its material in a direction opposite to that of screw conveyor 51. Furthermore, each of the screw conveyors 49, 51 is inclined upwardly from their respective feed ends. In a preferred embodiment, each of the screw conveyors 49, 50, 51 is inclined at an angle of between approximately 2° and approximately 4°, and more preferably approximately 3°, from horizontal.

Other angular inclinations may likewise be suitable, depending on the particular application associated with apparatus 21. The inclination of the conveyors 49, 51, according to the present invention, is selected so that, on the one hand, throughput of the materials is within the objectives of the application, and so that, on the other hand, a suitable amount of intermixing takes place before discharge of the combined materials. Otherwise stated, the inclinations need to be chosen to avoid undesirable build up of material at the feed end of the conveyors and, at the same time, assuring adequate intermixing of the materials.

Because conveyors 49, 51 are generally next to each other in channel 47, conveyors 49, 51 present opposing sides to each other and the flow of material is not inhibited between conveyors 49, 51 within channel 47. As such, material being transported by one of the conveyors is free to intermix with material being transported by the other of the conveyors. This intermixing occurs over at least a majority of the operative lengths of screw conveyors 49, 51, and as seen in FIG. 3, preferably over most of the operative lengths of screw conveyors 49, 51. The free and open communication of materials between the two conveyors defines a mixing zone 55, as best seen in FIGS. 3 and 6. In the preferred embodiment, screw conveyor 51 comprises a secondary screw conveyor and transports kiln dust or slag outwardly from its feed end 32 toward feed end 31 of conveyor 49, which is preferably the primary screw conveyor. Primary screw conveyor 49, in turn, transports synthetic gypsum from its feed end 31 in a direction opposite the transport direction of secondary conveyor 49. As such, the kiln dust or slag transported in one direction by secondary conveyor 51 intermixes over the operative lengths of screw conveyor 51 with synthetic gypsum being transported in the opposite direction by primary screw conveyor 49. The intermixed synthetic gypsum and kiln dust ultimately reaches the discharge end 37 (FIG. 4) of primary screw conveyor 49, by which time the materials have been sufficiently intermixed for further processing.

Preferably, primary screw conveyor 49 has a larger diameter than that of secondary screw conveyor 51, more preferably the diameter of primary screw conveyor 49 is approximately two times that of secondary screw conveyor 51, and most preferably, the diameter of primary screw conveyors 49 is approximately 12 inches, whereas the diameter of the secondary screw conveyor is approximately six inches.

Screw conveyors 49, 51 are driven by a motor 57 suitable for the particular cement materials, throughput, and intermixing requirements of the application. Motor 57 is preferably located at one end of housing 45, and drives both screw conveyors 49, 51 from such end. Motor 57 is suitably connected to rotate primary screw conveyor 49 in a first direction and secondary screw conveyor 51 in a second direction opposite the first direction. In this embodiment, primary screw conveyor rotates counterclockwise, whereas secondary screw conveyor rotates clockwise, relative to the motor 57.

Significantly, motor 57 includes suitable mechanisms to vary the rate of rotation of one or both of screw conveyors 49, 51. This allows different “blends” of the materials, as well as different throughputs, depending on the desired applications. In one suitable application, both of the screw conveyors are driven at 30 revolutions per minute, with a throughput of approximately 30 tons per hour.

The motor 57 is selected to have enough power to drive both screw conveyors 49, 51 and produce a shearing action between the two materials being intermixed. With regard to such shearing action, the outer edges or fins of conveyors 49, 51 are preferably spaced from each other by a minimum of about one-half inch and by a maximum of about one inch.

The elongated channel 47 is substantially enclosed, including not only a U-shaped base portion 59 (FIG. 2), but also a top cover 61. Top cover 61 includes a removable portion or door 63 for accessing the respective operative lengths of screw conveyors 49, 51, such as for cleaning, maintenance, or other observations of the operation of the apparatus 21. By substantially enclosing channel 47, the generation of undesirable dust is minimized.

The operation of the present invention is readily appreciated from the foregoing description. Screw conveyors 49, 51 are driven by motor 57 so that each conveyor introduces the corresponding cement-making material at its feed end, transports such material along the operative lengths of respective conveyors and transports such material along the operative length of such conveyors. Because the screw conveyors rotate in opposite directions relative to each other and communicate with each other by virtue of sharing the same elongated channel 47, the materials carried by the respective conveyors intermix along a majority of the operative conveyor lengths during transport. A shearing action occurs which enhances the mixing process. The mixed material is ultimately conveyed to discharge end 37 of the primary screw conveyor 49, after which the mixture is further used in the cement-making process.

In addition to the advantages apparent from the foregoing description, the invention economically provides for mixing synthetic gypsum with kiln dust or slag, while eliminating the need for separate, costly components.

The throughput and mixing ratios are more readily controllable by means of the present invention.

The economical and advantageous operation of the invention leads to significant savings when the dual conveyor apparatus is incorporated into the larger cement-making process.

It will be appreciated that those skilled in the art may vary certain structures and dimensions of the invention, and may otherwise construct variations which skill or fancy may suggest. Such variations are within the scope of the present invention, which is delimited by the following claims, and is not limited by the preferred embodiments.

What is claimed is:

1. An apparatus for mixing and conveying cement-making materials from at least two sources, the apparatus comprising:
a housing having an elongated channel defined therein; and
first and second screw conveyors extending longitudinally through the channel, the screw conveyors having respective feed ends and operative lengths extending longitudinally from the respective feed ends, the screw conveyors being secured generally next to each other to share the channel over a majority of their respective, operative lengths, the screw conveyors being oriented to convey respective materials in opposite directions from each other and inclined slightly upwardly from their respective feed ends, the orientation and location of the screw conveyors in the channel defining a mixing zone in the channel, the feed ends being located on opposite sides of the mixing zone, whereby the cement-making materials introduced at the feed ends of the screw conveyors are intermixed and transported simultaneously.

2. The apparatus of claim 1, wherein the screw conveyors have respective discharge ends, the discharge end of the second screw conveyor being located near the feed end of the first screw conveyor and the discharge end of the first screw conveyor being located to discharge the cement-making material for further processing.

3. The apparatus of claim 1, wherein the screw conveyors are inclined at an angle ranging between approximately 2° and approximately 4° from horizontal.

4. The apparatus of claim 3, wherein the screw conveyors are inclined at an angle of approximately 3° from horizontal.

5. The apparatus of claim 1, wherein the screw conveyors comprise a primary screw conveyor and a secondary screw conveyor, the primary screw conveyor having a diameter larger than the secondary screw conveyor.

6. The apparatus of claim 5, wherein the primary screw conveyor has a diameter approximately two times that of the secondary screw conveyor.

7. The apparatus of claim 5, wherein the primary screw conveyor is adapted to transport synthetic gypsum and the secondary screw conveyor is adapted to transport at least one material selected from the group consisting of kiln dust and slag.

8. The apparatus of claim 1, further comprising a motor located at one end of the housing and operatively connected to both of the screw conveyors to drive the screw conveyors rotationally.

9. The apparatus of claim 8, wherein the motor is connected to the screw conveyors to rotate the primary screw conveyor in a first direction relative to the motor and the second screw conveyor in a second direction opposite the first direction relative to the drive motor.

10. The apparatus of claim 8, wherein the motor includes means to vary the rate of rotation of at least one of the screw conveyors.

11. The apparatus of claim 1, wherein the channel is sufficiently enclosed to minimize generation of dust otherwise generated during mixing of the materials.

12. The apparatus of claim 11, wherein the channel comprises a removable door for accessing the respective operative lengths of the screw conveyors.

13. The apparatus of claim 1, further comprising:
a hopper at each of the feed ends of the screw conveyors for holding materials to be introduced into the feed ends;
a synthetic gypsum feeder operatively connected to the hopper at the first screw conveyor;
the hopper at the second screw conveyor comprising a bin adapted to hold one of the materials selected from the group consisting of kiln dust and slag, the first screw conveyor having a discharge end for discharging the cement-making materials after intermixing.
a belt conveyor positioned to receive thereon the cement-making materials discharged from the discharge end of the first screw conveyor.

14. An apparatus for mixing synthetic gypsum and kiln dust and transporting the mixture for further processing, the apparatus comprising:
a housing having an elongated channel defined therein; and
first and second screw conveyors extending longitudinally through the channel, the screw conveyors having respective feed ends and operative lengths extending longitudinally from the respective feed ends, the screw conveyors being secured generally next to each other to share the channel over a majority of their respective, operative lengths, the screw conveyors being oriented to convey respective materials in opposite directions from each other and inclined slightly upwardly from their respective feed ends, the orientation and location of the screw conveyors in the channel defining a mixing zone in the channel;
wherein the channel is substantially closed to reduce generation of dust;
wherein each of the screw conveyors is inclined at an angle of approximately 3° with respect to the horizontal; and
further comprising a motor located at one of the ends of the housing, the motor connected to rotate the screw conveyors in opposite directions relative to the motor; and
a synthetic gypsum feeder operatively connected to the feed end of the first screw conveyor.

15. A method of mixing synthetic gypsum and kiln dust, comprising the steps of:
positioning a primary and a secondary screw conveyor so that the screw conveyors share a channel over a majority of the operative lengths of the screw conveyors, inclining each of the conveyors slightly upwardly from their respective feed ends, and orienting the screw conveyors to convey in opposite directions;
introducing synthetic gypsum to the primary screw conveyor at the feed end thereof;
introducing kiln dust at the feed end of the secondary screw conveyor;
operating the screw conveyors so that they are rotated in opposite directions relative to one end of the channel to intermix the synthetic gypsum and the kiln dust within the channel; and
discharging the intermixed materials from the discharge end of the primary screw conveyor.
